(19) United States
(12) Patent Application Publication
(10) Pub. No.: US 2024/0427831 A1
(43) Pub. Date: Dec. 26, 2024

(54) GILDED MATRIX COMPUTER PROGRAM PRODUCT AND METHOD OF IMPLEMENTING THE SAME

(71) Applicant: Leif Eric Stacey, Davie, FL (US)

(72) Inventor: Leif Eric Stacey, Davie, FL (US)

(21) Appl. No.: 18/237,336

(22) Filed: Aug. 23, 2023

Related U.S. Application Data
(60) Provisional application No. 63/373,202, filed on Aug. 23, 2022.

(51) Int. Cl. G06F 16/957; G06F 3/0482; G06F 3/0484

(52) U.S. Cl. CPC G06F 16/9577; G06F 3/0482; G06F 3/0484

(57) ABSTRACT

The embodiments described herein generally relate to computer program products or application instructions systematically employing various hybrid versions of a Fibonacci Rectangle with an approximate ratio of 1.6 to 1. to generate GUI elements including menu pages configured to display a number of menu squares or rectangles, each including distinct menus or nested menu boxes with corresponding selectable actions and which may display one or more media types and may contain a potential link to another inter-domain or intra-domain application window. The system is configured to maximize the amount of space that a web page content can be displayed in. Web menu pages and gallery viewers may include menu boxes, nested images, media assets, or pages. Media asset types may include images, third-party or outside web application APIs, videos, rendered HTML or other code, or the like.

### CROSS-REFERENCE TO RELATED APPLICATIONS

This application claims the benefit of U.S. Provisional Application No. 63/373,202 filed Aug. 23, 2022 which is incorporated herein, in its entirety, by reference.

### TECHNICAL FIELD

The embodiments generally relate to computer program products implementing a graphical user interface (GUI) designed for optimal display to human eye.

### BACKGROUND

Negative methods of GUI display that are deleterious to the user experience may include partial or cascading and jittery page asset loading; opening a new page causes sudden page load/unload; optic white page background causes eye strain/damage; small fonts, cluttered and numerous links; large portion of potential display space taken up by browser/software headers containing seldom used controls and web navigation bars; poor design display crossover from desktop, to tablet, to phone; poor navigability across potential pages of the website/software/OSX;

no aesthetic, intuitive organizational flow; navigation/understanding of the display is specific language dependent as current designs are centered around text menus/hyperlinks text; and gallery viewing pages for image/artwork taking up a small portion of the screen with poor transitions between images and long page load times if page assets are on a remote server.

Humans are visual creatures, 70% of sense receptors are concentrated in the eyes and 50% of the brain is dedicated to processing visual information. This visual information is collected by the eyes through the human field of view, which perceives text at 10 degrees, shape at 30 degrees and color at 60 degrees. This is one reason current and previous text-based models of digital display are inherently limited. A visual interface that engages all 3 fields must be superior to these current text-based interfaces. If an interface can minimize its text displays and instead emphasize the shape field with a cohesive layout and emphasize the color field through image dominant displays of information, then an interface can increase both the information density and speed to human comprehension. Therefore, there are abundant opportunities to improve GUIs through taking greater advantage of the full perceptual potential of the complex human eye.

In addition to the previously mentioned limitations of the current text-based interfaces, their language dependent nature is likely the most disqualifying aspect for humans worldwide to understand the information being displayed. The innovation that can transition information display from a text basis to an image basis is a tool that would become a universal digital interface; giving every human eye the ability to comprehend the information from a fit for purpose visual interface.

To achieve the outcome of a fully engaged and perceiving human eye, a system implementing what can be called a human interface (HI) is needed. Cross-culturally, humans see beauty and harmony in the Fibonacci Sequence (FS) and its visual representations. The Fibonacci sequence is an infinite series, beginning at 1, where the next number is the sum of the preceding two numbers: 1, 1, 2, 3, 5, 8, 13, 21, and so on. When this FS is visualized by boxes in proportion to their Fibonacci Number, then the renowned shape referred to as a Fibonacci Rectangle (FR) is created. The FR approaches a dimension of 1.618 to 1 as more numbers of the FS are represented in a FR (this 1.618 ratio is often called the ‘Golden Ratio’). This ˜1.6 to 1 proportion is very close to the proportion of a standard sized sheet of printer paper, computer display dimensions and dimensions of many different forms of screened devices. A HI derived from a FR has the potential to employ an already desired and widely utilized dimension to maximize the amount of screen dedicated to displaying universally perceptible visual information.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended to determine the scope of the claimed subject matter.

The embodiments generally relate to a computer program products systematically employing an approximate 1.6 to 1 ratio rectangle for primary page media display derived from a Fibonacci Rectangle (FR) to generate HI elements including, but not limited to, menu pages and gallery viewers to facilitate improved user engagement with the HI system. The HI will algorithmically take up the maximum displayable space in a viewing window and all page content will be entirely displayed in that window. This adherence to a single page display concept avoids any need to scroll to content and also allows for HI pages to be designed in and print to a single sheet of 8.5″×11″ paper. The system may include publishing functionality and editing functionality to publish or edit the HI and HI elements.

Both the foregoing general description and the following detailed description present embodiments intended to provide an overview or framework for understanding the nature and character of the embodiments disclosed herein. Any accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a visualization of the Fibonacci sequence, visualized via a base 8 FR, with a golden spiral, according to some embodiments;

FIGS. 2-14 illustrate variations of a graphical user interface of the disclosed HI system, called a menu page, according to some embodiments;

FIG. 15 illustrates an example of a computer system that may be utilized to execute various procedures, including the processes, systems, and methods, according to some embodiments;

FIG. 16 illustrates an example of a computing system operating the application instructions described herein, according to some embodiments;

FIGS. 17A and 17B illustrate an example of a method of linking described herein, according to some embodiments;

FIGS. 18A and 18B illustrate variations of a graphical user interface of the disclosed HI system, according to some embodiments;

FIGS. 19A, 19 B, 19 C, and 19 D illustrate variations of a graphical user interface of the disclosed HI system, according to some embodiments; and

FIGS. 20A, 20B, and 20C illustrate variations of a graphical user interface of the disclosed HI system, according to some embodiments.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

As used herein, the term “user” may be utilized to relate to any user of the system including individuals accessing the system, such as individual residential users and commercial application users. “User” is distinct from administrator user and page designer.

The embodiments generally relate to computer program products or application instructions systematically employing an approximately 1.6 to 1 ratio derived from an FR to generate HI elements including menu pages configured to display a number of menu squares or rectangles, each including distinct menus with corresponding selectable actions and which may display one or more forms of media, including images, APIs or rendered code such as HTML. According to some embodiments, 1-12 menus may be generated from a base-5 FR; 1-20 menus generated from a base-8 FR; 1-33 menus generated from a base-13 FR; or 1-54 menus generated from a base-21 FR.

According to some embodiments, the system may include editing functionality for menu boxes, menu pages, gallery viewer pages, and more. Edit Mode includes functionality allowing a page designer to drag and drop media, add API's, create new pages, merge/segment menus, apply links and active state settings to menus, change border/background color and many other page functions. The server is active in many of these tasks and a SQL database is maintained to store site and page information so that each page may be dynamically generated via PHP with settings from the SQL databases and according to what media assets have been added and are stored in the server folder structure.

Editing functionality is distinct from published versions of the system and HI. Published HI's are generated when a page designer in Edit Mode publishes the site according to its current Edit Mode state. This is a custom publishing software function that, according to some embodiments, writes the relevant settings that are stored in the SQL databases to the page in an obfuscated HTML and JavaScript document. According to some embodiments, the system may provide custom publishing software functionality to publish to application forms other than web pages. This series of published pages and their corresponding assets can be added to the root folder of a web domain and will operate like a typical website. According to some embodiments, the only use of SQL databases for a published site is to maintain user information.

Editing functionality may further include the capacity to edit page header icons and functions, create child and global link types, operate various edit mode dialogues, alter layout media assets and link statuses, upload images, delete images, use the undo/redo media alteration actions, manage horizontal to vertical menu layout configurations, page fade-in and media transition timings, determining the order in which menus are displayed vertically and horizontally, adjusting page attributes, links, or images, media management, upload or deletion of viewer media, drag and drop functionality for rearranging media assets, write HTML alt tags to images, adjust HTML meta tags such as, but not limited to, title, keyword, author and description, control of master site settings, root settings, and page settings, control and management of user profiles, Golden Root management, site/Golden Root/page minimum user security access levels and site administrator settings.

The HI, according to some embodiments, when it is first asked to open a page, will instead open into a page called a Golden Container Page (GCP). This GCP will reside in the same domain root folder as the page being opened. The GCP will then have the user's device create an HTML iFrame and load the page to open in that iFrame. The GCP page itself will not have any visible content as only the content of the GCP's currently displayed iFrame will be shown to the user. The GCP will persist through the user's entire session in the HI, only the displayed iFrame with-in the GCP will be changed. This use of the GCP allows for the user to remain in full-screen when the user clicks a link and for the Golden Link actions to function smoothly.

According to some embodiments, menu page display boxes, or the gallery viewer primary media window may be filled with media, for example, if a page designer has added media to a particular box, then that will be displayed. If no media has been added by a page designer, the system will display a default box that will have borders and fill colors appearing in line with the default box theme that the page designer designates. These default boxes may or may not display a logo, the empty box's name, and the empty box's image dimensions. According to some embodiments, in a menu page, images or media may be distinguished as either ‘Initial Images’ or ‘Active Images’ and each will have their own distinct default box designs.

In a menu page, each individual menu may include a selectable link to navigate to a subsequent menu page or gallery viewer, or any other page type inside or outside of the current domain. Menu pages and gallery viewers may include nested images, media assets, APIs, rendered HTML or other code, and may be editable via media asset drag and drop functionality and various Edit Mode settings dialogue boxes.

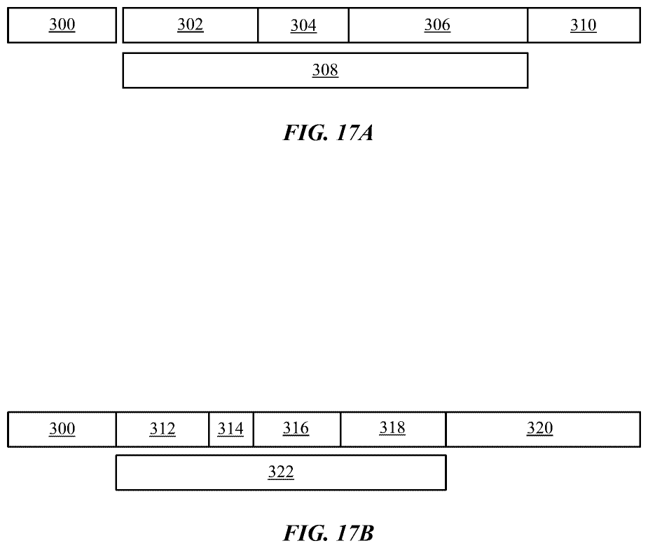

As used herein, “Golden Link” or “link” or variations on that term refers to how the HI may, according to some embodiments, detect a user initiated or system initiated open a new page action. Upon initiating an open new page action, the GCP will create a new, hidden iFrame and begin loading the new page inside of it while simultaneously executing a fade-out of the currently displayed iFrame. Once the page in the currently displayed iFrame is faded-out, that iFrame will be deleted from the GCP and the partially/fully loaded page in the new, hidden iFrame will be faded-in to the user after certain asset download requirements are met. No parts of that new page's iFrame will fade-in until the old page has completed its fade-out. This ensures that each time a new page is opened, the old page smoothly fades-out, then the new page starts from black, and then fades-in assets in a custom asset loading order determined by the HI page type. This manner of loading is described further in the description of FIG. 17, among others.

In Edit Mode, when a link is created in a menu then that link will either be to a current domain child or global link or link to any other page type inside or outside the current domain. When a child page is created, an entire new page will be created either as a menu page, gallery viewer page or other HI page type. That new child page will be linked to the menu page that created it, through, according to some embodiment, a menu box or a radio button. The creating page will be referred in relationship to this new page as the ‘parent page’. The new page will become a part of the Golden Root it was created in, and may, dependent on the setting made by the page designer, inherit all, some, or none of that Golden Root's characteristics set by the page designer. The system may utilize multiple Golden Roots in the HI to break up the traditionally single, large tree link structure of a website, instead allowing the website or application to operate via a plurality of distinct Golden Roots.

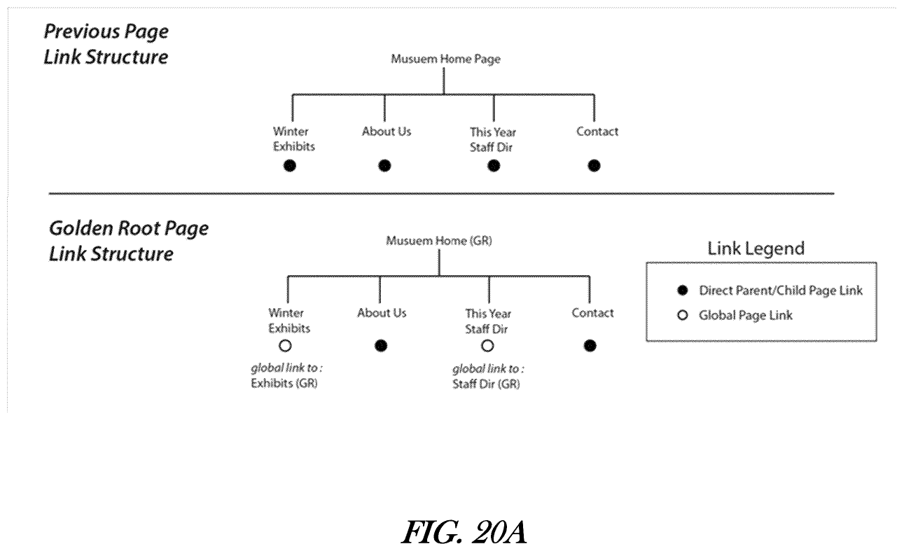

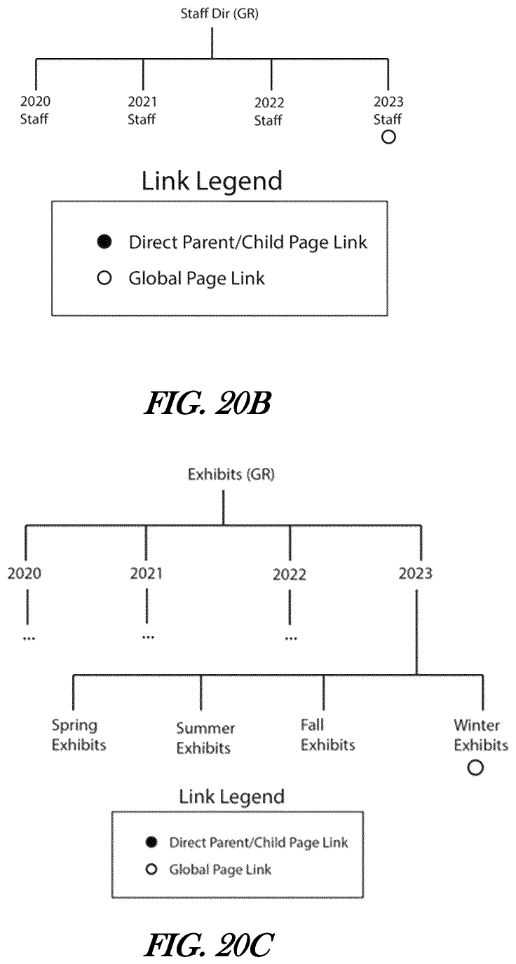

The structure of the HI leverages the many benefits of this unique feature called a Golden Root. Traditional website structures usually consist of one very large and unwieldly tree of page links (see FIG. 20A). The unique approach of the HI is to create a distributed network of smaller, independently functioning Golden Root link structures (see FIG. 20B).

The page designer may then utilize the unique ability of using global links to link to any page across various Golden Roots when creating the final structure of their website/application for their end user (see FIG. 20C).

Each Golden Root may operate like a mini website of its own and may have unique settings made by the page designer that effect all pages in that Golden Root's structure, including, but not limited to background/border colors, security access levels, media/page-load transition timings, layout rotation states and header nav icons.

According to some embodiments, the Edit Mode further leverages the power of these Golden Roots through administrative user (AU) actions that allow for a Golden Root to be copied. This copy function is useful in circumstances such as archiving a Golden Root in its current state or creating a Golden Root that serves as a template for a fixed set of pages whose structure periodically repeats but content varies, like a football team's yearly player roster or game schedule.

When a Golden Root is copied, the AU can choose if the new copy will have the same meta tag values or the same meta tags with a suffix or prefix added or to clear all the meta tags entirely. The AU user may also choose to copy or clear the general root settings of the copied root, such as but not limited to, border/background colors, custom nav logos, default box themes, viewer image preload amount, edit mode capability, security access settings, media/page-load transition timings and layout rotation states.

The AU may choose if the copied Gallery Viewers page will retain important details, such as but not limited to, keeping or deleting all added page media, undo/redo values, alt tag values and media source/type lock settings. Similarly, the AU may decide if copied Menu pages will retain or delete attributes, such as but not limited to, page menu box images/media, undo/redo values and active/inactive global links within the copied root.

The AU may execute other Golden Root actions, such as but not limited to, creating a new Golden Root, renaming a Golden Root or deleting a Golden Root.

When a global link is created, it is a link that will, according to some embodiments, open a pre-existing page within the current domain. That link can be to a page in the current Golden Root, or another Golden Root.

A menu page may also contain radio buttons in the header that can be clicked to navigate to a new page that is either a child or global link or a link to another page type, either inside or outside the current domain.

In a menu page, each separate menu box may contain a second image layer called an active image. This active image may be conditionally shown when a user clicks the menu, or it may be set to permanent display. This provides multi-dimensional design flexibility as the active image may either be a full opacity image, or it may employ a partially transparent background so that the underlying initial image partially displays.

Each menu page can adapt to display in horizontal or vertical orientations for optimal display to humans across all screen size and orientation iterations of, but not limited to, screened devices such as computers, tablets and smartphones.

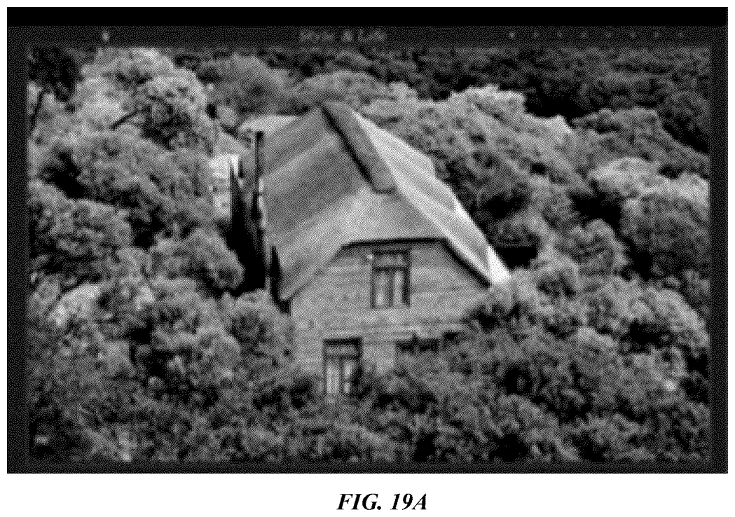

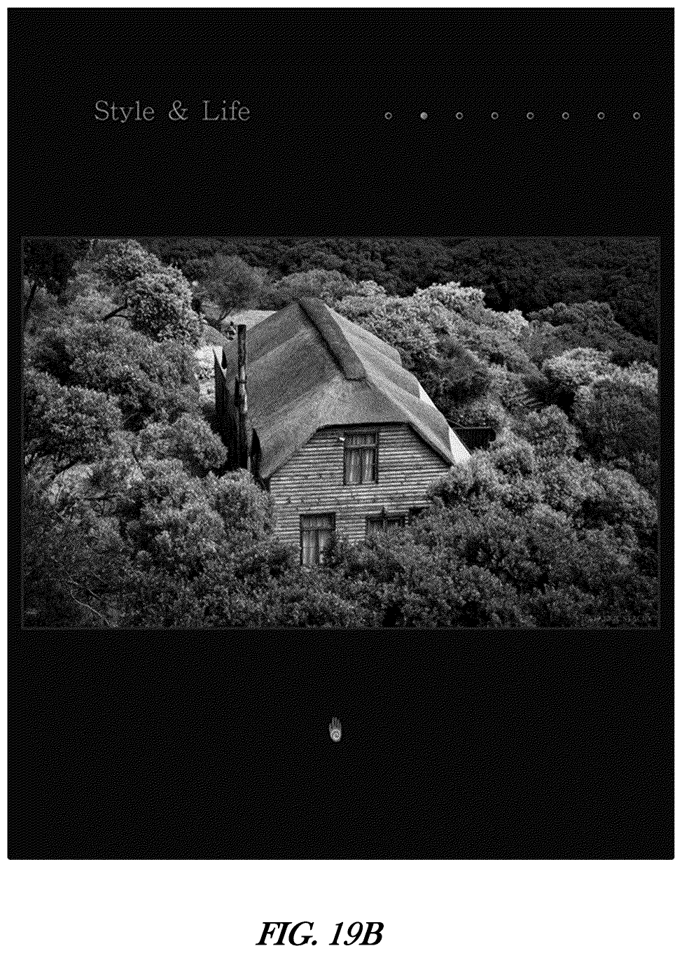

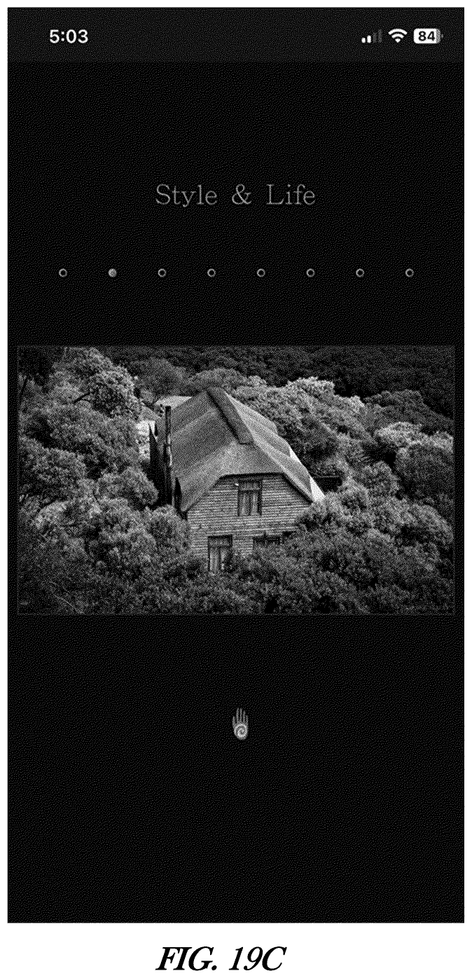

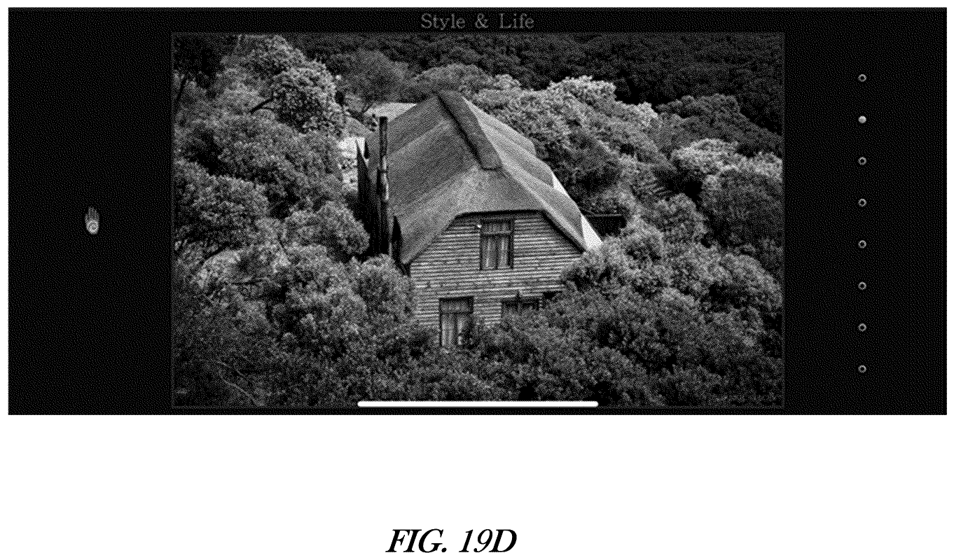

The embodiments generally relate to computer program products systematically employing an approximately 1.6 to 1 ratio to generate HI elements including gallery viewer pages (sometimes referenced as a ‘gallery page’ or ‘viewer page’ or ‘viewer’) configured to display the currently selected media asset. The gallery viewer page is distinct from the menu page in that it displays the currently selected media using the entire FR. When a new media position is selected the previously displayed media is faded out and then the newly selected media is faded in. According to some embodiments, the media position may be represented by a radio button in the upper right side of the header. Media asset types may include images, third-party or outside web application APIs, videos, rendered HTML or other code, or the like. Also, where a menu page has two potential display version; horizontal or vertical, the gallery viewer has four; 1. Desktop full screen horizontal, tablet horizontal (FIG. 19A). 2. Tablet vertical, desktop browser adjusted to vertical window display (FIG. 19B). 3. Phone vertical (FIG. 19C). 4. Phone horizontal (FIG. 19D).

One of the most inefficient and negative user experiences is waiting for a page to load its images. In a standard GUI, this is most likely to occur in a generic Media Viewer page type (example: an image carousel on a photographer's website, an image gallery from a news story) as the Media Viewer page type has larger-sized image assets that may take far longer to download from the server. To address this negative slow speed to load issue, if a menu page links to a gallery viewer page, the disclosed HI system will pre-download a set number of images from any directly linked Gallery Viewer page. This pre-download of Gallery Viewer images occurs in the background of a menu page only after the entirety of that menu page's assets are loaded and displayed to the user. A higher set number of images to preload (preload number set by the page designer) will allow the user to have a near-instant access to the entirety of that gallery viewer's images, even on a virgin viewer page load.

The drawback to this viewer page image preload is the client computer may download a lot of images to Viewer Pages it never visits. A lower set amount of image pre-downloads will ensure the user never waits for the first gallery image to load, but if they scroll quickly through the media in that viewer page, they may have to wait for some of the other images to load. Conversely, the drawback to a higher preload number is the user's browser will download more potentially unseen gallery viewer images and the advantage is it will ensure that a user will instantly have access to all viewer page media and can scroll across all media position immediately on page load. The gallery viewer page is designed to view various media types optimally through utilizing as much available screen space in the user's computer/device as possible.

An adaptive HI display maximizer, utilizing the GCP and iFrames, may be configured to maximize web page content size and feature presentation when the system detects that a first page load is enacted, a web browser window has changed size; a browser/device exits or enters “full screen”; a device display has been rotated; a user scrolls the page or any other action that might necessitate this function. The HI display maximizer will read the size of the new content window, determine the device/browser window orientation, and choose whether to display the web page content in a horizontal or vertical orientation and finally calculate the maximum size it can make the displayed content. This maximum size will be applied and the layout will be shown to this new size.

The HI system is optimized for and may include persistent full-screen capability which may be entered into by a user interaction. This full-screen mode is designed for, but not limited to internet browser use and its purpose is to simulate a full-screen application by hiding any browser controls and/or web URL nav bars and putting the content of the HI inside the entire user's screen (devices such as tablet, phones may still display a thin bar showing time/battery level etc.). Some websites utilize a similar full-screen function (though their layouts typically aren't optimized for full-screen display), but every time they open a new page, that full-screen mode is exited. The HI currently solves for this forced full-screen exit through the GCP and its use of iFrames. The GCP itself will be put in full-screen mode when it is initiated by the user. Thus, when a new link is opened, only the iFrame's with-in the GCP will be altered and the full screen status of the GCP will remain undisturbed. This unique, persistent full screen also applies to tablets, phones, or similar touch screen devices. One scenario in which this this device full screen may be entered is when the user scrolls up, the browser bar then disappears, the layout fades out and then fades back in using the entire screen, mimicking the full screen display of an application. The system may algorithmically resize to maximize its displayed size in the device screen.

Various hybrid menu page layouts may be systematically generated through the technique of menus merging, more simplistically referred to as ‘merging’ in this document. The two lowest number, individual unmerged boxes in the FR may be merged to create a single, rectangular merged menu box. This merging can continue until there is only one, full size menu box remaining in the layout. The merging of a menu layout is executed by the page designer in a dialogue box of the Edit Mode.

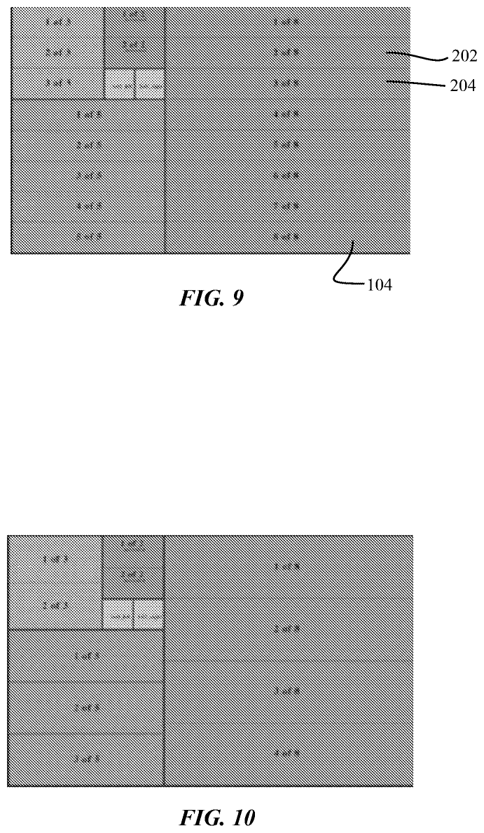

Additionally, various hybrid menu layouts may be systematically generated through menu segmenting, more simplistically referred to as ‘segmenting’ in this document. Menu segmenting breaks individual menus into nested horizontal or vertical segments. The number of these segments should not exceed the number the box represents in the FS or value in a value-based menu. For example, the 8 box can have up to 8 segments, whereas the 3 box may have up to 3 segments. As can be seen in FIG. 9, excluding the two segmenting ineligible middle 1 boxes, each menu box has been maximally segmented, demonstrating how each of the menu boxes may include a plurality of nested menu boxes. If this base-8 FR is maximally segmented horizontally or vertically, then it will yield 20 separate and independently functioning menu boxes. The segmenting of a menu layout is executed by the page designer in a dialogue box of the Edit Mode.

By implementing the merging and/or segmenting of FRs it is possible to generate ˜80 unique menu page layouts from a base 5 FR; ˜670 unique menu page layouts from a base 8 FR; ˜8300 unique menu page layouts from a base 13 FR; ˜174,000 unique menu page layouts from a base 21 FR. These ranges of possible menus for each base #FR treat an equal numbered vertical segmentation and an equal numbered horizontal segmentation of a menu box as identical. If they were counted as different the potential number of menus would massively increase over theses listed ranges.

According to some embodiments, when transitioning a menu page to the vertical layout, the menu order of some or all of the segmented menu sets may need to be reversed. For example, if menu box 3 set is fully segmented, then the default vertical menu order from top to bottom is 1,2,3. If the page designer reverses box set 3, then the menu order from top to bottom would be 3,2,1.

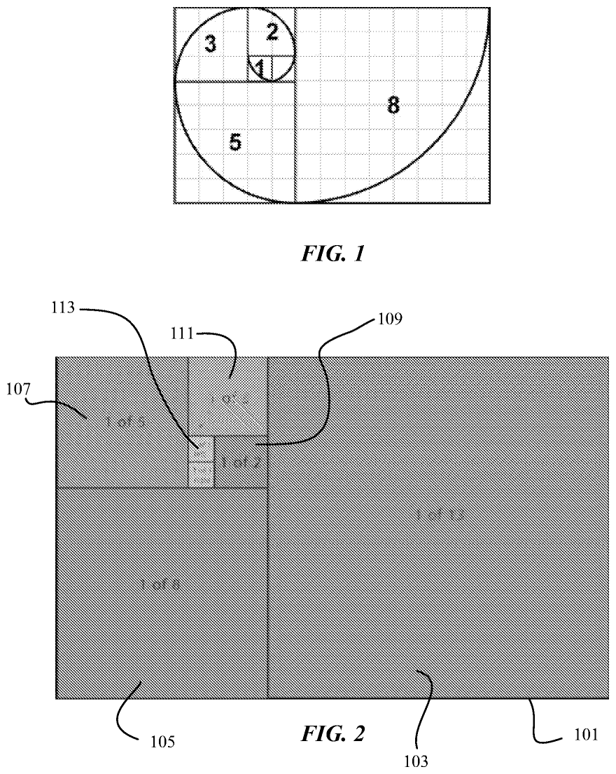

FIG. 1 depicts a base-8 Fibonacci Rectangle with a golden spiral which can form the foundation needed to generate a menu page. Each menu page begins its initial form in a FR with an approximate 1.6 to 1 ratio with nested squares that are identical to various FR base values, such as base 5, base 8, or base 13, or base 21. Each menu may be value-based dependent on the page designers use of the merging and/or segmenting techniques applied to the boxes of a FR to create distinct menu boxes.

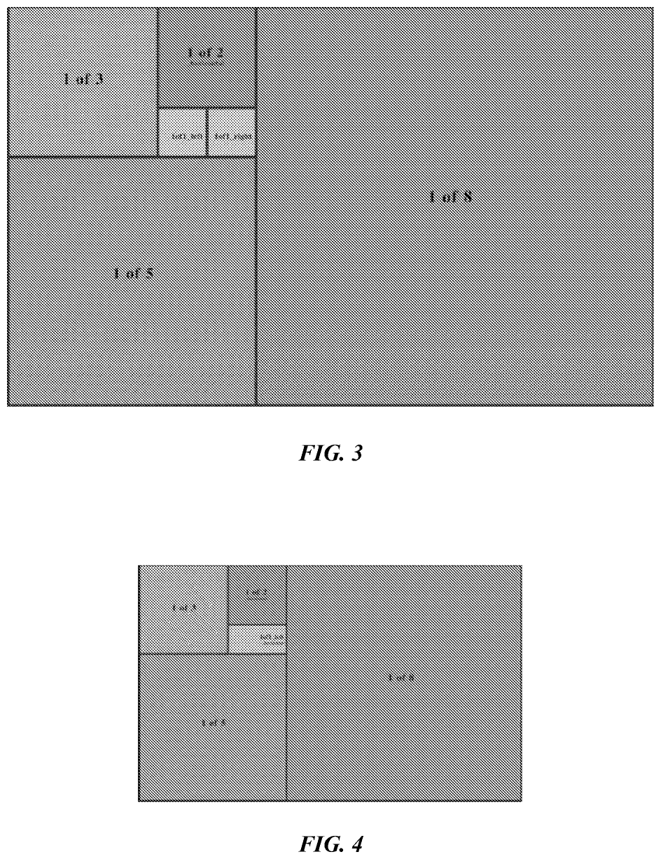

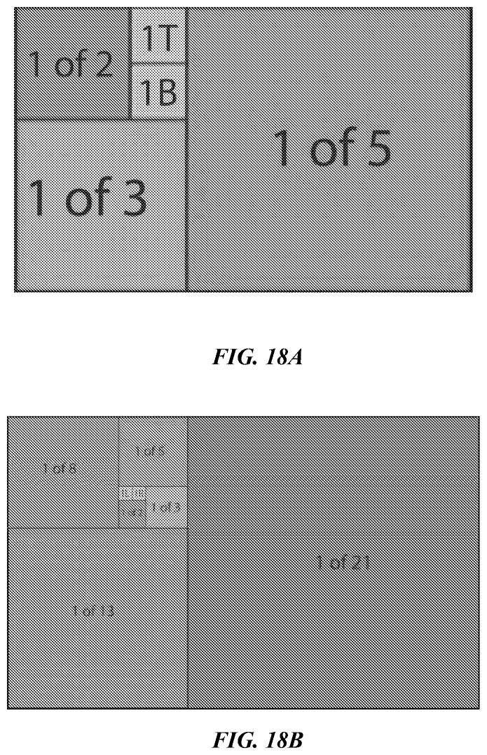

FIG. 2 depicts one variation of a gilded matrix computer program product including a base 13 menu box on a menu page. Each menu page 101 may include a plurality of menu boxes 103, 105, 107, 109, 111, and 113, utilizing the foundations of a FR. Each menu page is derived from one of four base-#FRs, i.e. base-5 as seen in FIG. 18A; base-8 as seen in FIG. 3; base-13 as seen in FIG. 2; and base-21 as in FIG. 18B.

FIG. 3 depicts one variation of a gilded matrix computer program product derived from a base 8 menu box. Various hybrid menu layouts may be systematically generated through menu merging. Menu merging combines the two lowest number menu boxes into a single, rectangular menu box, as depicted in FIGS. 3 through 8.

FIG. 4 depicts one variation of a gilded matrix computer program product menu page that is derived from a base-8 FR where the 1 and 1 rectangular middle boxes are merged into a single rectangular menu box.

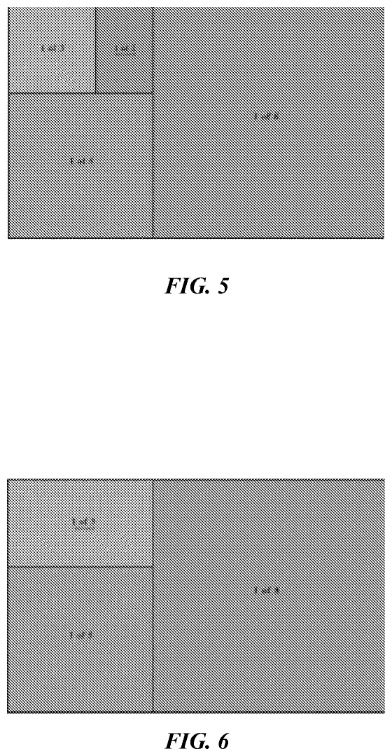

FIG. 5 depicts one variation of a gilded matrix computer program product including a menu page derived from a base-8 FR whose 1 boxes and 2 box are merged into a single rectangular menu box.

FIG. 6 depicts one variation of a gilded matrix computer program product including a menu page derived from a base-8 FR whose 1 boxes, 2 box and 3 box are merged into a single rectangular menu box.

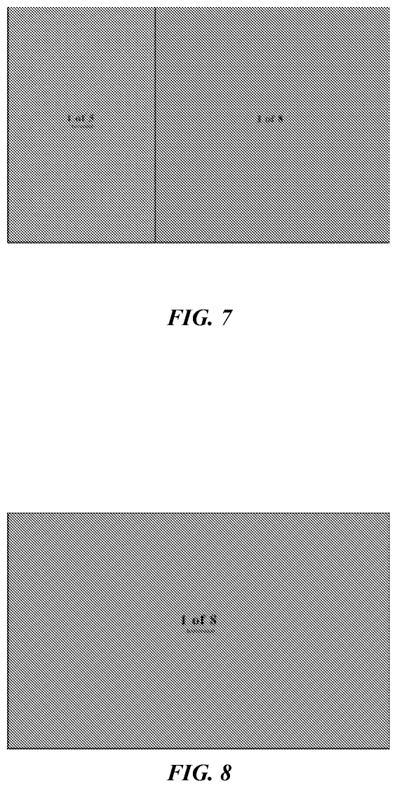

FIG. 7 depicts one variation of a gilded matrix computer program product including a menu page derived from a base-8 FR whose 1 boxes, 2 box, 3 box and 5 box are merged into a single rectangular menu box.

FIG. 8 depicts one variation of a gilded matrix computer program product including a menu page derived from a base-8 FR whose 1 boxes, 2 box, 3 box, 5 box and 8 box are merged into a single rectangular menu box.

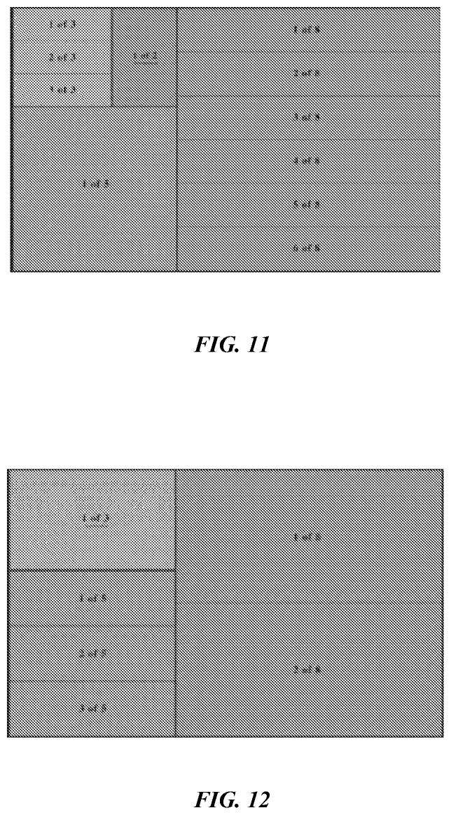

FIG. 9-12 depicts various arrangements of a HI implementing the previously described menu segmenting and/or merging technique.

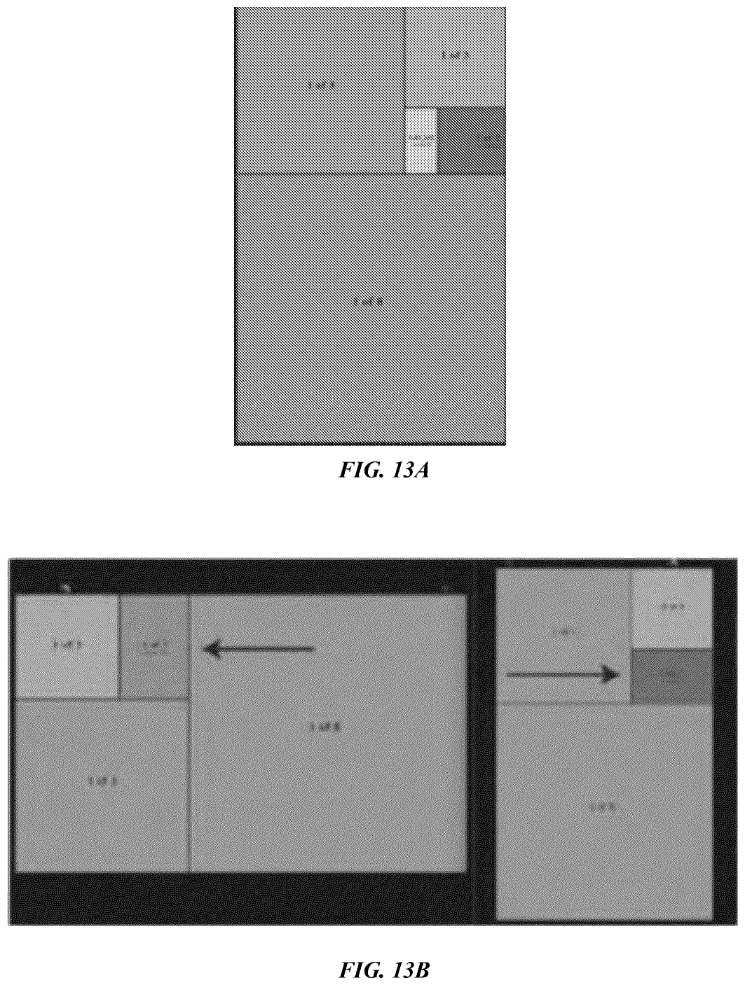

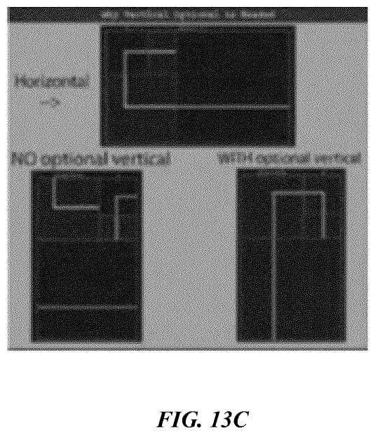

FIG. 13A, 13B, 13C depicts how the HI menu page adapts to the vertical orientations encountered in a computer's resized browser window, smart phone, tablet and various other screened technologies.

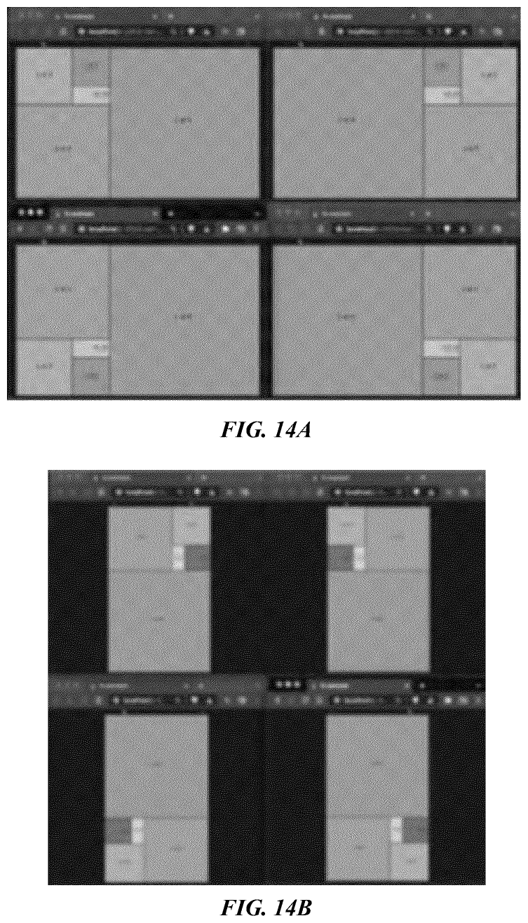

FIG. 14A and 14B depict how the page designer will have the ability to display a menu layout in 4 different rotational states through inverting the layout over the x-axis and/or inverting over the y-axis. The horizontal and vertical orientation layout have this ability. The rotational state setting for the horizontal and vertical layouts can be set independently.

In use, the HI system may be configured to automatically change displayed images of a menu page when transitioning from a horizontal layout (as in FIGS. 2-12) to a vertical layout (as in FIG. 13A). Every Menu box combination may have one or more menu boxes that is a different dimension in the vertical layout. This is a called a ‘Mandatory Vertical Image’ and it must be included by the page designer for a menu page's assets to be complete (an example showing the menu boxes that require a Mandatory Vertical Image are depicted in FIG. 13B). Additionally, when the layout switches to the vertical orientation, even though some of the image's dimensions will fit in the vertical orientation version of the layout, they may not maintain the visual design integrity established in the horizontal layout. In this case, the layout may have ‘Optional Vertical Images’ placed in it by the page designer, enabling the vertical orientation layout to maintain the visual design integrity, this is demonstrated in FIG. 13C.

When an HI page layout is displayed in a smart phone, or similar device type, in the horizontal orientation the Go back Page Nav Icon may be moved from the header to the right/left side of the screen. If this icon were to remain in the header, it would exit the full-screen mode in their phone when a user pressed the icon. Moving this logo to the side prevents this full screen exit while also allowing the user to hold the phone with both hands, providing easy access to pressing the icon with their thumb (see FIG. 19D).

The adaptive HI display may be configured to “flip” or otherwise invert the menu page layouts, as seen in FIG. 14A and 14B, based on user input and/or page designer settings. This flipped rotational state can be used to adapt the HI for different cultures who might not read top/bottom and left/right as is what the default setting of the HI is designed to display for.

Images displayed in each menu box may include a mandatory initial image and an elective active image. The initial image is always visible and should not have a transparent background. The initial image may have a border to make the menu box boundaries clearer. The active image might be a ‘.png’ file that contains text and/or artwork with a partially transparent background allowing part of the initial image will still show. The active image may also be a non-transparent image that will completely conceal the initial image once it is faded in. The elective Active image has three potential states: “1. Off: not shown and cannot be activated via a menu click; “2. Click to activate”: a user click on the menu will fade this image in over the initial image; “3. Permanent Active State” the image will be displayed on page load and remain permanently visible in the layout.

According to some embodiments, each menu box may have a golden link to another web page if the designer assigns it a link. When the mouse cursor hovers over a menu box, if a link will be opened on a user click, then the mouse cursor on the user's screen will depict a hand. If no link can be opened, then the cursor will be the default pointer. If the menu has an active link, how that link is accessed is dependent on that menu's elective active image state setting: 1. Active state turned OFF: when the mouse hovers over the menu the hand cursor icon will show, when the user clicks the menu image the page enters that link. 2. Active state turned On, not permanent: when the mouse hovers over the menu the default arrow cursor will show. When the user clicks the menu the active state image will fade in and the cursor will change into the hand icon. If the user clicks the menu again the page enters that link. Permanent 3. Active state turned ON: when the mouse hovers over the menu the hand cursor will show and when the user clicks the menu box the page enters that link.

According to some embodiments a webpage implementing the HI system may have page links accessed by clicking individual menu boxes. As example there is a maximum potential 20 page links from the menu boxes in a layout if that menu page is derived from a fully segmented base-8 FR. However, it is also an option to have radio buttons in the upper right side of the header that may also lead to additional potential page links.

Additionally, the HI system may be configured to facilitate printing to the standard 8.5″×11″ printer paper, as the FR layout of any HI page fits nicely inside these paper dimension in both horizontal and vertical display modes. This provides a great advantage over current GUI's, webpages or other software displays, which often print only partially across many pages and are seldom usable in their fractured, printed form. This printability of the HI allows book designers to create layouts and concepts in the HI, with intent of their final display form to be inside of a physical book. Furthermore, the HI's ability to be represented in the printer paper dimension allows the page designer to use paper to design and conceptualize HI menus before creating them in Edit Mode. The HI's breakdown of this digital-display/printer-paper barrier opens a massive array of potential uses across various physical and digital media mediums.

According to some embodiments, the HI system may provide for improved, smooth page and image load. To achieve this each HI page is loaded in 3 phases. In phase 1, the page waits until all of the system is read by the browser and ready to implement, it then requests from the server the phase 2 page assets. In phase 2, the HI page will fade in the border of the FR menu layout, the page background, radio buttons, title and nav logo simultaneously once these assets are loaded and ready in the user's device. The new page fade in duration for these assets will be set by the page designer. The page then begins requests from the server for the phase 3 assets. Phase 3 will be accomplished differently accordingly to HI page type.

In viewer page's phase 3, the user's browser requests the first viewer image that is displayed to the user from the server. When the first image is downloaded from server, that image is faded-in and the layout looks complete to the user. The user's browser will then request the second image, and the last image in the Gallery Viewer's media positions. This second/last image load anticipates that the likely initial image change initiated by the user will be left (opening last viewer image) or right (opening second viewer image) of the currently displayed image in relationship to the radio buttons representing the media order. Once the second/last images fully load, the browser will then request the remaining Gallery Viewer images two at a time until all of the viewer's media has been downloaded from the server.

In a menu page's phase 3, the individual menus will be faded in only after every menu image in that menu box set has been downloaded and readied (as example if the menu is not segmented, then only 1 mandatory initial image and the 1 elective active image will need to be loaded, where-as if the menu box set has 3 segments, then 3 initial and 3 elective active images must be loaded before the entire menu box set is faded in). Once that menu box set has its image download from the server, it will fade-in according to the Menus Block Fade In duration set by the page designer. The order of the menu boxes being faded in can be customized by the page designer, however the default setting is to start with the smallest number menu box and then load each larger menu box sequentially. The action to retrieve menu images from the server is called the menus staggered image asset request function.

To implement the menus staggered image asset request function the HI will instruct the user's computer to request images from only the first menu boxes set to load from the server. Only once the 1st target set of images are loaded will the HI request the next set of menu images in the load order. This sequence repeats until all the page menu images are loaded and achieves two important design goals. 1. Provides a much quicker method to display the 1st images to the user in the shortest amount of time during a new page load than the traditionally used method of downloading all page image assets simultaneously from the server. 2. Enables a consistent and reliable pattern of page asset loading for a better user experience. According to some embodiments, the page designer can also set a Stagger Menu Blocks Loads duration for an impressive effect. If this is set to 0.3 seconds, then if menu box 5 and menu box 8 load their images nearly simultaneously (or these images already exists in the user computer's cache), then menu 5 will fade in immediately, and menu box 8 will fade in after a 0.3 second delay.

Referring to FIG. 17A, in which a traditional hyperlink action operates, a user, at step 300, is currently viewing a fully loaded webpage. Step 308 includes all steps necessary in traditional hyperlinking. In step 302 a user may input request of a new page and a new page may include no content initially. In step 304 the new page may be downloaded including basic text and small images which may be shown as they are read into a browser. These assets may snap load in an unpredictable order. Larger assets may remain downloading. In step 306 larger assets are downloaded completely and are displayed as the web page takes a final appearance. Assets continue to snap load, typically from top to bottom. In step 310, the new page may be fully displayed.

Referring to FIG. 17B, which depicts the present system's Golden Link means for downloading and displaying web pages, a plurality of steps 322 may provide for a smoother user experience and faster download times of web page assets. This Golden Link action utilizes the GCP and its iFrame functions mentioned earlier. In step 312 a new page request may be received and the current web page will fade out over a fixed time period, while simultaneously the new page has begun to download. In step 314 new web page download continues, including downloading of basic assets while the display remains black. Step 316, initial downloads have completed, the application page may fade from black to display a title asset, FR border, headers navs, radio buttons and other secondary image assets. In this step, the application page's fundamental visual structure is established and the primary visible media then begins staged downloading. In step 318, the gallery viewer page or menu page will begin their unique phase 3 loading sequence, as was described above. Once the page's primary, visible media assets complete their download and are faded into the main layout, the page appears complete to a viewer looking at the page on a display. In the case of a viewer page, non-visible primary media will continue downloading. In step 320 non-visible primary media completes its download. In this way, the present system may provide a means for faster loading of visible and non-visible media to create a smoother user experience. Comparatively, step 322 often takes less time than step 308, while also providing an improved visual user experience.

Similarly, when a user clicks to open a new page link, the HI system may minimize download times of newly opened page by instantly downloading the new page from a server so that the system and image asset download can begin sooner compared to traditional web pages. This action happens in the background via the GCP and its iFrame functionality while the previous page is still being faded out. This can dramatically shorten the amount of time the user waits for a new page to be loaded from the server and is a key asset to a positive user experience.

According to some embodiments, the HI system may adjust radio button positions according to screen orientation and device type, such as based on the size of the viewing window, device display size, or device orientation (see FIGS. 19). These gold radio buttons each represent a visual piece of media, be it an image, API or rendered HTML code or other code types that will be displayed in the main viewer window. Clicking these buttons in a Gallery Viewer will fade out the current media in the main viewer window and show the new selected media. The fade-in/fade-out transition of the media will be determined by the page designer. The user can also use a key input, such as an arrow or number key press, or swipe left or right with a touch screen to change the media displayed in the main viewer menu.

The maximum number of radio buttons in the header of an HI page is around 8, but an HI may page can contain more media/links. If the page has more than 8 media/link entries then a gold arrow will appear next to the last radio button on the right, when it is clicked the radio buttons will then represent the next set of media/link positions and a gold arrow will appear to the left of the first media button. If that left arrow is clicked the radio buttons will again represent the first 8 media/link positions in the page. This arrow clicking method can navigate through almost unlimited sets of 8 images/links. A small number display near the radio buttons will also show the current media/link selected number and the total media/link amounts in the HI page.

The disclosed HI system, including the gallery viewer page and the menu page, may also display and allow for interaction with embedded API's and their vast scope of uses.

The disclosed HI system may include a multitude of universal page functions and capabilities. The HI system may include navigational icons for navigating within the FR GUI as well as navigating between webpages both with-in or outside the current domain. The HI system may include customizable web page titles, loading and unloading transitions, page loading efficiency features previously described, asset preloading features previously described, and an adaptive HI display maximizer.

According to some embodiments, the HI system may include a plurality of menu pages, gallery pages and/or other HI page types arranged in separate browser windows across the user's screen in rows and/or columns. Each one of these small windows retains all their independent HI page functionality. The user may click the browser window they wish to work in so that it has the focus and then that window can be interacted with. If full-screen is activated in that window it will enter full-screen mode as usual and when full-screen is exited it will return to its original position in the browser window arrangement. A single screen can hold about 12 separate windows, if a user has multiple monitors those monitors may also display around 12 HI pages each.

The system may be configured to allow page designers to edit various aspects of menu boxes, menu pages, and gallery viewers, among others. Editing functionality may include the ability to edit the page file name, various HTML meta tags, adding/deleting page image assets, downloading of page assets, alter image alt tags, create/remove API link URLs, various page design elements and colors, menu link actions, vertical or horizontal orientation rotation states, custom vertical orientation image displays, page/image assets fade in settings, page security, user access settings and undo/redo actions in regards to altering page media assets.

In Edit Mode, the page info dialogue will display the basic page information such as page name, page title, page description, page template type, page's parent, and the full page URL. If the user has the proper permissions, then they will also be able to change the page file name (which subsequently will change the full page URL of the current page), page title and the HTML meta tag description. In the footer of this dialogue the user will be able to view their own user profile, log out and open the page navigator. Clicking a download icon will download all the page's current media assets to the client's computer. If there are inactive media assets (in viewer only) then a user will also be given the option to download or ignore these. Inactive media assets occur when the media position is set to API, but there is also an image in that position, then that image will be considered inactive . . . or vice versa.

According to some embodiments, the system may be configured for indicating missing menu assets and links, or missing gallery viewer assets in a log that can be generated from a menu page Edit Mode dialogue.

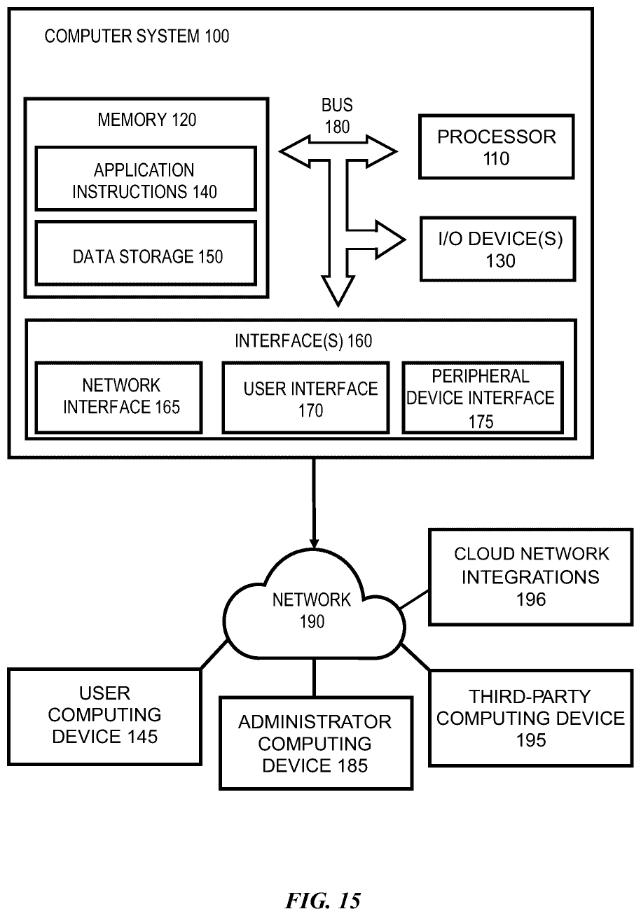

FIG. 15 illustrates an example of a computer system 100 that may be utilized to execute various procedures, including the processes, systems, and methods described herein. Computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein, specifically the HI system previously described. Application instructions 140 may be implemented in various embodiments using any desired programming language, scripting language, or combination of programming and/or scripting languages (e.g., C, C++, C #, JAVA, JAVASCRIPT, PERL, etc.).

The application instructions 140 may be configured to systematically to employ layouts derived from FR's with the approximate display dimension ratio of, for example, 1.6 to 1 to generate HI elements including menu pages configured to display a number of menu squares or rectangles, each including distinct menus with corresponding selectable actions and which may display one or more images. Images, media, or data may be pulled from data storage 150 and displayed within any of the menu pages or gallery viewers. In this way, the system may maximize the amount of space that the main page content is displayed with when viewed as a page, such as a web page, on a device display. Each individual menu may include a custom open new page link action to navigate to a subsequent menu page or gallery viewer or to another page type both inside and outside of the current domain. Menu pages and gallery viewers may include nested images, media, or pages, and may be editable via drag and drop functionality when read from the data storage 150 or memory 120.

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanical system device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of systems and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microsystem, firmware instructions, state-setting data, configuration data for integrated circuitry, or either source system or object system written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. The computer system 100 may be in operable communication with the cloud network integrations 196 over the network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized to establish credentials, create a user profile, and otherwise interact with the system. The third-party computing device 195 may be utilized by third parties to receive communications from the user computing device and/or administrative computing device 185.

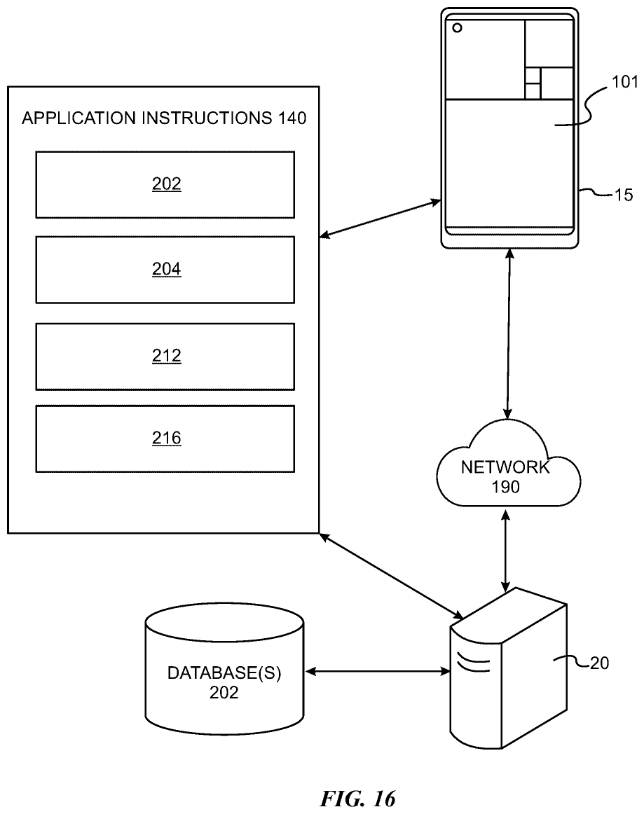

FIG. 16 illustrates an example of a computer architecture for the application instructions 140 operated via a computing system. Application instructions 140 comprises several modules and engines configured to execute the functionalities of the application instructions 140, and a database 202 configured to facilitate how data is stored and managed in one or more databases, such as cloud-based storage. In particular, FIG. 16 is a block diagram showing the modules and engines needed to perform specific tasks via the application instructions 140. The application instructions 140 may operate on any or all of a user device 15, such as a desktop computer or smart device, or cloud-based computing server 20.

Referring to FIG. 16, the computing system 100 operating the application instructions 140 comprises one or more modules having the necessary routines and data structures for performing specific tasks, and one or more engines configured to determine how the platform manages and manipulates data. In some embodiments, the application instructions 140 comprises one or more of a communication module 202, a database engine 204, a user module 212, and a display module 216.

In some embodiments, the communication module 202 is configured for receiving, processing, and transmitting a user command and/or user input. In such embodiments, the communication module 202 performs communication functions between various devices, including a user computing device 15, an administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 allows each user to transmit and receive information which may be used by the system. The communication module 202 is operable to transmit alerts and notifications to secondary user devices as described hereinabove.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. The database engine 204 allows each user and module associated with the system to transmit and receive information stored in various databases, including mattress maintenance data.

In some embodiments, the user module 212 facilitates the creation of a user account for the application system. The user module 212 may allow the user to input account information, user preferences, media, data, and the like. User accounts may upload, download, and otherwise store data on the system and tag data or other user. User module 212 may permit viewing and interaction with the HI system, or editing and management, such as via an administrator user.

In some embodiments, the display module 216 is configured to display one or more GUIs or HIs, including, e.g., one or more user interfaces including the HI system 101 described herein, including displaying media or data in a FR format. In some embodiments, the display module 216 is configured to temporarily generate and display various pieces of information in response to one or more commands or operations, such as the maintenance notifications or confirmation of upload or download of data. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed via the display module 216 may not be persistently stored.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, system, software, program and/or the like.

The following description of variants is only illustrative of components, elements, acts, product, and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

According to variation 1, a system for generating a gilded matrix graphical user interface, the system may include at least one computing device; a memory that stores computer-executable components; a processor that executes the computer-executable components stored in the memory, wherein the computer-executable components include instructions for: retrieving at least one media asset from a database; generating a first webpage; and displaying the at least one media asset on the first webpage on a display of a device with the primary media assets being contained in a full screen rectangle with an approximate ratio of 1.6 to 1 whose shape and internal menu box structure was derived from a Fibonacci Rectangle.

Variation 2 may include a system as in variation 1, wherein the at least one media

asset includes a plurality of media assets.

Variation 3 may include a system as in variation 1 or 2, wherein each individual media asset within the Fibonacci Rectangle may conditionally include a link to a second webpage.

Variation 4 may include a system as in any of variations 1 through 3, wherein displaying the at least one media asset on a display in a Fibonacci sequence includes displaying the plurality of media assets in a Fibonacci rectangle.

Variation 5 may include a system as in any of variations 1 through 4, wherein each media asset within the plurality of media assets is displayed within a menu box.

Variation 6 may include the system of any of variations 1 through 5, wherein each box includes a plurality of nested media assets. wherein each nested media asset within the plurality of nested media assets includes a link to a second webpage.

Variation 7 may include the system of any of variations 1 through 6, wherein the second webpage displays at least one second media asset on the display of a device in a second Fibonacci Rectangle based layout.

Variation 8 may include the system of any of variations 1 through 7, wherein the second at least one media asset includes a second plurality of media assets.

Variation 9 may include the system of any of variations 1 through 8, wherein each individual media asset in the second plurality of media assets includes a link to a third webpage and wherein each media asset within the second plurality of media assets is displayed within a menu box.

Variation 10 may include the system of any of variations 1 through 9, further including generating at least one hybrid menu page layout via at least one of merging or segmenting.

Variation 11 may include the system of any of variations 1 through 10, wherein displaying the at least one media asset on the first webpage on a display of a device includes persistent full screen functionality.

Variation 12 may include the system of any of variations 1 through 11, further including: detecting at least one of a change in a browser window size, full screen display, display orientation, or user scrolling on a display; reading the size of a display; and adapting displaying the at least one media asset on the first webpage on a display of a device

According to variation 13, a nontransitory computer-readable media maintaining instructions of a first instance of an application that, when executed by one or more processors of a first computing device, program the one or more processors to retrieve a plurality of media assets from a database accessed in operable communication with the first computing device; determining a sequential order of the plurality of media assets; generating at least one webpage; and displaying the plurality of media assets on a first webpage on a display of a second computing device, the plurality of media assets being contained in a full screen rectangle with an approximate ratio of 1.6 to 1 whose shape and internal menu box structure was derived from a Fibonacci Rectangle.

Variation 14 may include the non-transitory computer-readable media of variation 13, wherein displaying the plurality of media assets on a first webpage includes generating at least one of 1-12 menus generated from a base-5 FR; 1-20 menus generated from a base-8 FR; 1-33 menus generated from a base-13 FR; or 1-54 menus generated from a base-21 FR.

Variation 15 may include the non-transitory computer-readable media as in any of variations 13 through 14, further including: publishing an HI from an editing mode including writing at least one relevant setting stored in the SQL databases to a page in an obfuscated HTML document; and adding a published HI to a root folder of a web domain.

Variation 16 may include the non-transitory computer-readable media as in any of variations 13 through 15, further including: opening a persistent golden container page; generating a first HTML iFrame; loading a web page to open within the first HTML iFrame; executing a fade-out of a currently displayed second iFrame; deleting the second iFrame; and executing a fade-in of the first HTML iFrame.

Variation 17 may include the non-transitory computer-readable media as in any of variations 13 through 16, further including: requesting at least one page asset; fading-in a border of an FR menu layout, a page background, at least one radio button, a title, and a navigation logo; and fading-in at least one individual menu box.

Variation 18 may include the non-transitory computer-readable media as in any of variations 13 through 17, wherein retrieve a plurality of media assets from a database accessed in operable communication with the first computing device includes: staggering media asset requests including requesting a first set of media assets in at least one menu box from a database and requesting a second set of media assets in at least one second menu box from the database.

Variation 19 may include the non-transitory computer-readable media as in any of variations 13 through 18, further including: adjusting a menu order of at least one menu set; displaying a menu layout in at least one of four rotational states; automatically adjusting displayed media assets based on at least one of a horizontal or vertical layout; and automatically adjusting displayed menu orders, menu layouts, or media assets when printed to paper.

According to variation 20, a system for generating a gilded matrix graphical user interface may include at least one computing device in operable connection with a network; a memory that stores computer-executable components; a processor that executes the computer-executable components stored in the memory, wherein the computer-executable components include instructions for: retrieving a plurality of media assets from a database accessed in operable communication with a first computing device; determining a sequential order of the plurality of media assets; generating at least one webpage; and displaying the plurality of media assets on the at least one webpage on a display of a second computing device within a menu box, the plurality of media assets being contained in a full screen rectangle with an approximate ratio of 1.6 to 1 whose shape and internal menu box structure was derived from a Fibonacci Rectangle and wherein each individual media asset within the Fibonacci Rectangle may conditionally include a link to a second webpage.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for generating a gilded matrix graphical user interface, the system comprising:
at least one computing device;
a memory that stores computer-executable components;
a processor that executes the computer-executable components stored in the memory, wherein the computer-executable components comprise instructions for:
retrieving at least one media asset from a database;
generating a first webpage; and
displaying the at least one media asset on the first webpage on a display of a device with the primary media assets being contained in a full screen rectangle with an approximate ratio of 1.6 to 1 whose shape and internal menu box structure was derived from a Fibonacci Rectangle.

2. The system of claim 1, wherein the at least one media asset comprises a plurality of media assets.

3. The system of claim 2, wherein each individual media asset within the Fibonacci Rectangle may conditionally comprises a link to a second webpage.

4. The system of claim 3, wherein displaying the at least one media asset on a display in a Fibonacci sequence comprises displaying the plurality of media assets in a Fibonacci rectangle.

5. The system of claim 4, wherein each media asset within the plurality of media assets is displayed within a menu box.

6. The system of claim 5, wherein each box comprises a plurality of nested media assets. wherein each nested media asset within the plurality of nested media assets comprises a link to a second webpage.

7. The system of claim 6, wherein the second webpage displays at least one second media asset on the display of a device in a second Fibonacci Rectangle based layout.

8. The system of claim 7, wherein the second at least one media asset comprises a second plurality of media assets.

9. The system of claim 8, wherein each individual media asset in the second plurality of media assets comprises a link to a third webpage and wherein each media asset within the second plurality of media assets is displayed within a menu box

10. The system of claim 1, further comprising generating at least one hybrid menu page layout via at least one of merging or segmenting.

11. The system of claim 1, wherein displaying the at least one media asset on the first webpage on a display of a device comprises persistent full screen functionality.

12. The system of claim 1, further comprising:
detecting at least one of a change in a browser window size, full screen display, display orientation, or user scrolling on a display;
reading the size of a display; and
adapting displaying the at least one media asset on the first webpage on a display of a device

13. A non-transitory computer-readable media maintaining instructions of a first instance of an application that, when executed by one or more processors of a first computing device, program the one or more processors to:
retrieve a plurality of media assets from a database accessed in operable communication with the first computing device;
determining a sequential order of the plurality of media assets;
generating at least one webpage; and
displaying the plurality of media assets on a first webpage on a display of a second computing device, the plurality of media assets being contained in a full screen rectangle with an approximate ratio of 1.6 to 1 whose shape and internal menu box structure was derived from a Fibonacci Rectangle.

14. The non-transitory computer-readable media of claim 13, wherein displaying the plurality of media assets on a first webpage comprises generating at least one of 1-12 menus generated from a base-5 FR; 1-20 menus generated from a base-8 FR; 1-33 menus generated from a base-13 FR; or 1-54 menus generated from a base-21 FR.

15. The non-transitory computer-readable media of claim 13, further comprising:
publishing an HI from an editing mode comprising writing at least one relevant setting stored in the SQL databases to a page in an obfuscated HTML document; and
adding a published HI to a root folder of a web domain.

16. The non-transitory computer-readable media of claim 13, further comprising:
opening a persistent golden container page;
generating a first HTML iFrame;
loading a web page to open within the first HTML iFrame;
executing a fade-out of a currently displayed second iFrame;
deleting the second iFrame; and
executing a fade-in of the first HTML iFrame.

17. The non-transitory computer-readable media of claim 13, further comprising:
requesting at least one page asset;
fading-in a border of an FR menu layout, a page background, at least one radio button, a title, and a navigation logo; and
fading-in at least one individual menu box.

18. The non-transitory computer-readable media of claim 13, wherein retrieve a plurality of media assets from a database accessed in operable communication with the first computing device comprises:
staggering media asset requests comprising requesting a first set of media assets in at least one menu box from a database and requesting a second set of media assets in at least one second menu box from the database.

19. The non-transitory computer-readable media of claim 13, further comprising:
adjusting a menu order of at least one menu set;
displaying a menu layout in at least one of four rotational states;
automatically adjusting displayed media assets based on at least one of a horizontal or vertical layout; and
automatically adjusting displayed menu orders, menu layouts, or media assets when printed to paper.

20. A system for generating a gilded matrix graphical user interface, the system comprising:
at least one computing device in operable connection with a network;
a memory that stores computer-executable components;
a processor that executes the computer-executable components stored in the memory, wherein the computer-executable components comprise instructions for:
retrieving a plurality of media assets from a database accessed in operable communication with a first computing device;
determining a sequential order of the plurality of media assets;
generating at least one webpage; and
displaying the plurality of media assets on the at least one webpage on a display of a second computing device within a menu box, the plurality of media assets being contained in a full screen rectangle with an approximate ratio of 1.6 to 1 whose shape and internal menu box structure was derived from a Fibonacci Rectangle and wherein each individual media asset within the Fibonacci Rectangle may conditionally comprise a link to a second webpage.
